(19) United States
(12) Patent Application Publication
(10) Pub. No.: US 2026/0094860 A1
(43) Pub. Date: Apr. 2, 2026

(54) BATTERY CELL AND ELECTRICAL DEVICE

(71) Applicant: Xiamen Ampace Technology Limited, Xiamen (CN)

(72) Inventors: Xiao SHI, Xiamen (CN); Songyang SU, Xiamen (CN); Xinyu ZHENG, Xiamen (CN); Juan JIN, Xiamen (CN)

(73) Assignee: Xiamen Ampace Technology Limited, Xiamen (CN)

(21) Appl. No.: 19/341,148

(22) Filed: Sep. 26, 2025

(30) Foreign Application Priority Data
Sep. 29, 2024 (CN) 202411369125.1

(51) Int. Cl. H01M 10/04; H01M 4/02; H01M 4/38; H01M 4/587; H01M 50/131

(52) U.S. Cl. CPC H01M 10/0431; H01M 4/386; H01M 4/587; H01M 50/131; H01M 2004/027

(57) ABSTRACT

An electrode assembly of the battery cell is of a jelly-roll structure, the electrode assembly includes a negative electrode plate; along a winding direction of the electrode assembly, an elongation at break of the negative electrode plate is X0; along an extension direction of a winding axis of the electrode assembly, an elongation of the negative electrode plate is X1; and along a thickness direction of the electrode assembly, an expansion rate of the electrode assembly is X2, 0≤X0−(X1+X2)≤2%.

### CROSS-REFERENCE TO RELATED APPLICATIONS

This application claims the priority of Chinese Application No. 202411369125.1, filed on Sep. 29, 2024, the contents of which is incorporated herein by reference in its entirety

### TECHNICAL FIELD

This application relates to the technical field of batteries, and in particular, to a battery cell and an electrical device.

### BACKGROUND

Battery cells are widely used in fields such as portable electronic devices, electric means of transport, electric tools, drones, and energy storage devices. As application environments and conditions become increasingly complex, higher requirements are put forward to the safety performance of the battery cells.

### SUMMARY

Embodiments of this application provide a battery cell and an electrical device to improve the safety performance of the battery cell.

In a first aspect, an embodiment of this application provides a battery cell. The battery cell includes a shell and an electrode assembly. The electrode assembly is accommodated in the shell, the electrode assembly is of a jelly-roll structure, the electrode assembly includes a negative electrode plate, along a winding direction of the electrode assembly, an elongation at break of the negative electrode plate is X₀; along an extension direction of a winding axis of the electrode assembly, an elongation of the negative electrode plate is X₁; and along a thickness direction of the electrode assembly, an expansion rate of the electrode assembly is X₂, satisfying: 0≤X₀−(X₁+X₂)≤2%. When the battery cell is in a fully charged state, a length of the negative electrode plate along the extension direction of the winding axis of the electrode assembly is X₁₁, and a dimension of the electrode assembly along the thickness direction thereof is X₂₁. When the battery cell is in a fully discharged state, a length of the negative electrode plate along the extension direction of the winding axis of the electrode assembly is X₁₂, a dimension of the electrode assembly along the thickness direction thereof is X₂₂, a dimension of the electrode assembly along a width direction thereof is b, X₁=(X₁₁−X₁₂)/X₁₂, X₂=(X₂₁−X₂₂)/b, and the extension direction of the winding axis of the electrode assembly, the thickness direction of the electrode assembly, and the width direction of the electrode assembly are perpendicular to each other.

According to the battery cell of the embodiment of this application, if X₀−(X₁+X₂)<0, when the battery cell is in the fully charged state, the negative electrode plate is prone to expansion and breakage, resulting in capacity loss and burrs generated after the negative electrode plate breaks to easily cause safety problems. If X₀−(X₁+X₂)>2%, when the battery cell is in the fully charged state, the risk of breakage of the negative electrode plate is low, but the production cost increases. Therefore, 0≤X₀−(X₁+X₂)≤2% can not only reduce the risk of expansion and breakage of the negative electrode plate when the battery cell is fully charged and improve the safety performance of the battery cell, but also reduce the capacity loss of the battery cell and control the production cost of the battery cell.

In some embodiments of the first aspect of this application, 0.4%≤X₀−(X₁+X₂)≤1.5%.

In one or more of the above optional embodiments, when X₀−(X₁+X₂)≥0.4%, the risk of expansion and breakage of the negative electrode plate after the number of cycles of the battery cell increases can be reduced, thereby further improving the safety performance of the battery cell and prolonging the service life of the battery cell; and when X₀−(X₁+X₂)≤1.5%, it is conducive to controlling the production cost of the battery cell within a reasonable range. Therefore, 0.4%≤X₀−(X₁+X₂)≤1.5% can not only further reduce the risk of expansion and breakage of the negative electrode plate after the number of cycles of the battery cell increases, thereby further improving the safety performance of the battery cell and prolonging the service life of the battery cell, but also control the production cost of the battery cell.

In some embodiments of the first aspect of this application, the negative electrode plate includes a negative active material, and the negative active material includes silicon.

In one or more of the above optional embodiments, the negative active material includes silicon, which is conducive to making the battery cell have the advantages such as high energy density, low cost, and environmental friendliness.

In some embodiments of the first aspect of this application, a weight percentage content of the silicon in the negative active material is C, where 0<C<100%.

In one or more of the above optional embodiments, the weight percentage content of the silicon in the negative active material is greater than 0 and less than 100%, which not only is conducive to making the battery cell have the advantages such as high energy density and environmental friendliness, but also further controls the cost of the battery cell.

In some embodiments of the first aspect of this application, 15%≤C≤80%.

In one or more of the above optional embodiments, the weight percentage content of the silicon in the negative active material is greater than or equal to 15%, enabling the battery cell to achieve relatively high energy density, and the weight percentage content of the silicon in the negative active material is less than or equal to 80%, which is conducive to further controlling the cost of the battery cell.

In some embodiments of the first aspect of this application, the negative active material further includes graphite.

In one or more of the above optional embodiments, the negative active material further includes the graphite, which is conducive to improving the stability of the battery cell.

In some embodiments of the first aspect of this application, the battery cell includes a plurality of electrode assemblies, a number of electrode assemblies in the plurality of electrode assemblies is N, an accommodating space is formed inside the shell, and a dimension of the accommodating space along the thickness direction of the electrode assembly is H, where N≥2, and 0.5H/N≤X₂₂≤1.5H/N.

In one or more of the above optional embodiments, when X₂₂≥0.5H/N, the battery cell has a large capacity, and when X₂₂≤1.5H/N, it is avoided that the risk of expansion and breakage of the negative electrode plate is increased due to the excessive thickness of the electrode assembly, and the safety performance of the battery cell is improved.

In some embodiments of the first aspect of this application, the plurality of electrode assemblies are stacked along the thickness direction of the electrode assemblies; and the number of the electrode assemblies does not exceed four.

In one or more of the above optional embodiments, the battery cell includes a plurality of electrode assemblies. When the capacity of the battery cell remains constant, compared with the case that the battery cell includes a single electrode assembly, the battery cell in this solution includes the plurality of electrode assemblies, each electrode assembly may have a small thickness, and the smaller the thickness of the electrode assemblies, the lower the risk of breakage of negative electrode plates of the electrode assemblies, such that the safety performance of the battery cell is better. The number of electrode assemblies does not exceed four, which can reduce the process complexity, improve the production efficiency and reduce the production cost.

In some embodiments of the first aspect of this application, an accommodating space is formed inside the shell, and a dimension of the accommodating space along the thickness direction of the electrode assembly is H, where 5 mm≤H≤20 mm.

In one or more of the above optional embodiments, when H≥5 mm, an internal space of the shell of the battery cell is relatively large, which is conducive to making the battery cell and the like have relatively high energy density, and also making the processing of the shell easy; and when H≤20 mm, the processing difficulty and production cost of the battery cell are reduced.

In some embodiments of the first aspect of this application, 6 mm≤H≤15 mm.

In one or more of the above optional embodiments, when H≥6 mm, the internal space of the shell of the battery cell is even larger, which is conducive to making the battery cell and the like have high energy density, and also making the processing of the shell easy; and when H≤15 mm, the processing difficulty and production cost of the battery cell are further reduced.

In some embodiments of the first aspect of this application, 2.5 mm≤X₂₂≤10 mm.

In one or more of the above optional embodiments, the thickness of the electrode assembly is greater than or equal to 2.5 mm, which is conducive to making the electrode assembly have a relatively high capacity and facilitates the production and processing of the electrode assembly; and the thickness of the electrode assembly is less than or equal to 10 mm, thereby reducing the risk of expansion and breakage of the negative electrode plate of the battery cell in the fully charged state, and improving the safety of the battery cell.

In some embodiments of the first aspect of this application, 3 mm≤X₂₂≤7.5 mm.

In one or more of the above optional embodiments, the thickness of the electrode assembly is greater than or equal to 3 mm, which is conducive to making the electrode assembly have a higher capacity and facilitates the production and processing of the electrode assembly; and the thickness of the electrode assembly is less than or equal to 7.5 mm, thereby reducing the risk of expansion and breakage of the negative electrode plate of the battery cell in the fully charged state, and further improving the safety of the battery cell.

In a second aspect, an embodiment of this application provides an electrical device. The electrical device includes the battery cell according to any one of the above embodiments.

In one or more of the above optional embodiments, the battery cell provided in any one of the above embodiments has good safety, which is conducive to improving the electrical safety of the electrical device powered by the battery cell.

### BRIEF DESCRIPTION OF DRAWINGS

To describe technical solutions in embodiments of this application more clearly, the following outlines the drawings to be used in the embodiments. Understandably, the following drawings show merely some embodiments of this application, and therefore, are not intended to limit the scope.

FIG. 1 is a cross-sectional view of a battery cell according to some embodiments of this application;

FIG. 2 is a schematic structural diagram of an electrode assembly in a fully charged state according to some embodiments of this application;

FIG. 3 is a schematic structural diagram of the electrode assembly in a fully discharged state according to some embodiments of this application;

FIG. 4 is a schematic diagram of an unexpanded negative electrode plate after being unfolded according to some embodiments of this application; and

FIG. 5 is a schematic diagram of an expanded negative electrode plate after being unfolded according to some embodiments of this application.

### REFERENCE NUMERALS

100—Battery cell; 10—Shell; 11—First wall; 12—Second wall; 20—Electrode assembly; 21—Negative electrode plate; 22—Positive electrode plate; 23—Separator; X—Winding direction of the electrode assembly; X′—Length direction of the negative electrode plate; Y—Extension direction of a winding axis of the electrode assembly; Y′—Width direction of the negative electrode plate; Z—Width direction of the electrode assembly; K—Thickness direction of the electrode assembly; A1—Straight region; A2—Bent region; and Q—Accommodating space.

### DETAILED DESCRIPTION

To make the objectives, technical solutions, and advantages of some embodiments of this application clearer, the following gives a clear and complete description of the technical solutions in some embodiments of this application with reference to the drawings in some embodiments of this application. Apparently, the described embodiments are merely a part of but not all of the embodiments of this application. The components described and illustrated in the drawings according to the embodiments of this application generally may be arranged and designed in a variety of different configurations.

Therefore, the following detailed description of the embodiments of this application provided with reference to the drawings is not intended to limit the scope of this application as claimed, but merely represents selected embodiments of this application. All other embodiments derived by a person of ordinary skill in the art based on the embodiments of this application without making any creative efforts still fall within the protection scope of this application.

It needs to be noted that to the extent that no conflict occurs, the embodiments of this application and the features in the embodiments may be combined with each other.

It is hereby noted that similar reference numerals and letters indicate similar items in the following drawings. Therefore, once an item is defined in one drawing, the item does not need to be further defined or construed in subsequent drawings.

In the description of the embodiments of this application, it is hereby noted that an indicated direction or positional relationship is a direction or positional relationship based on illustration in the drawings, or a direction or positional relationship by which a product in use according to this application is usually placed, or a direction or positional relationship commonly understood by a person skilled in the art, and is merely intended for ease or brevity of describing this application, but does not indicate or imply that the indicated apparatus or component is necessarily located in the specified direction or constructed or operated in the specified direction. Therefore, the indicated direction or positional relationship is never to be understood as a limitation on this application. In addition, the terms “first”, “second”, “third”, and the like are used only for the purpose of differentiating descriptions and are not to be understood as indicating or implying relative importance.

In the description of embodiments of this application, unless otherwise expressly specified and defined, the terms “dispose”, “mount”, and “connect” are understood in a broad sense. For example, a “connection” may be a fixed connection, a detachable connection, or an integrated connection; and a “connection” may be a direct connection or an indirect connection implemented through an intermediary. For a person of ordinary skill in the art, the specific meaning of the above terms in this application may be understood according to specific circumstances.

Currently, as can be seen from the market trend, the application of battery cells is increasingly extensive. The battery cells are widely used in electric bicycles, electric motorcycles, electric automobiles, and other electric transportation, as well as in various fields such as electric tools, drones, and energy storage devices. The market demand for battery cells keeps soaring with the increase of the application fields of the battery cells, and the performance requirements for the battery cells are becoming higher.

The battery cells include jelly-roll battery cells and stacked battery cells. An electrode assembly of the jelly-roll battery cell is of a jelly-roll structure. For the jelly-roll electrode assembly, in the cycling process, a negative electrode plate will exhibit expansion. For different types of jelly-roll battery cells, the degrees of expansion of negative electrode plates vary. For example, the thickness change rate of a graphite negative electrode plate between a fully charged state and a fully discharged state ranges from 5% to 10%, an expansion rate of a pure silicon negative electrode can even exceed 100%, and an expansion rate of a composite negative electrode made of graphite and silicon falls between those of the two pure materials.

The expansion of the negative electrode plate will pull the electrode plate, causing deformation in both the length and width directions of the negative electrode plate. Additionally, for the jelly-roll structure, the expansion of the negative electrode plate and the increase in the thickness of the negative electrode plate lead to compression at winding corners (bent regions) of the electrode assembly, which further pulls the negative electrode plate at a main body position (straight region). When the negative electrode plate at the main body position is pulled to exceed the elongation at break of the negative electrode plate, the negative electrode plate will break. On one hand, the breakage may lead to capacity loss; on the other hand, burrs generated at the breakage position of the electrode plate cause safety risks. The thicker the battery cell, the higher the risk of breakage of the negative electrode plate.

Based on the above considerations, in order to alleviate the problem of breakage of the negative electrode plate due to expansion of the negative electrode plate, an embodiment of this application provides a battery cell. An electrode assembly of the battery cell is of a jelly-roll structure, the electrode assembly includes a negative electrode plate, along a winding direction of the electrode assembly, an elongation at break of the negative electrode plate is X₀, along an extension direction of a winding axis of the electrode assembly, an elongation of the negative electrode plate is X₁, and along a thickness direction of the electrode assembly, an expansion rate of the electrode assembly is X₂, satisfying: 0≤X₀−(X₁+X₂)≤2%. When the battery cell is in the fully charged state, a length of the negative electrode plate along the extension direction of the winding axis of the electrode assembly is X₁₁, and a dimension of the electrode assembly along the thickness direction thereof is X₂₁. When the battery cell is in the fully discharged state, a length of the negative electrode plate along the extension direction of the winding axis of the electrode assembly is X₁₂, a dimension of the electrode assembly along the thickness direction thereof is X₂₂, a dimension of the electrode assembly in a width direction thereof is b, X₁=(X₁₁−X₁₂)/X₁₂, X₂=(X₂₁−X₂₂)/b, and the extension direction of the winding axis of the electrode assembly, the thickness direction of the electrode assembly, and the width direction of the electrode assembly are perpendicular to each other.

If X₀−(X₁+X₂)<0, when the battery cell is in the fully charged state, the negative electrode plate is prone to expansion and breakage, resulting in capacity loss and burrs generated after the negative electrode plate breaks to easily cause safety problems. If X₀−(X₁+X₂)>2%, when the battery cell is in the fully charged state, the risk of breakage of the negative electrode plate 21 is low, but the production cost increases. Therefore, 0≤X0−(X1+X2)≤2% can not only reduce the risk of expansion and breakage of the negative electrode plate when the battery cell is fully charged and improve the safety performance of the battery cell, but also reduce the capacity loss of the battery cell and control the production cost of the battery cell.

The battery cell disclosed in the embodiments of this application may be used, but is not limited to, electrical devices such as electric two-wheelers, electric tools, drones, and energy storage devices. Alternatively, the battery cell meeting the working conditions of this application may be used as a power supply system of the electrical device, which is conducive to improving the safety performance of the battery cell.

An embodiment of this application provides an electrical device that uses a battery cell as a power supply. The electrical device may include, but is not limited to, electronic devices, electric tools, electric transportation, drones, and energy storage devices. The electronic device may include a cell phone, a tablet, a notebook computer, etc., the electric tool may include an electric drill, an electric saw, etc., and the electric transportation may include an electric vehicle, an electric motorcycle, an electric bicycle, etc.

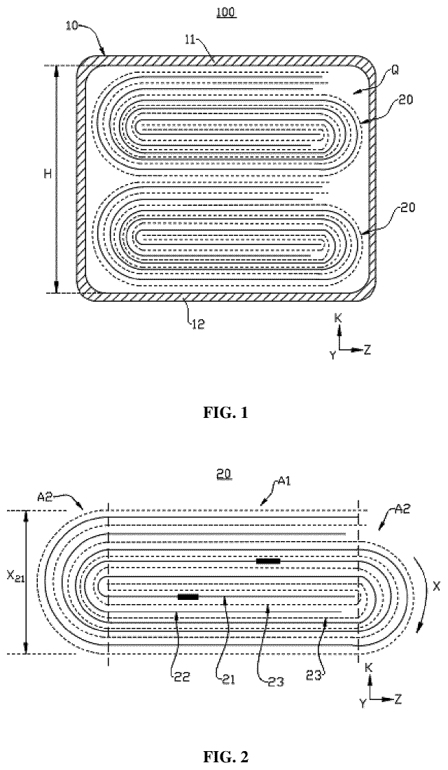

As shown in FIG. 1 to FIG. 5, an embodiment of this application provides a battery cell 100. The battery cell 100 includes a shell 10 and an electrode assembly 20. The electrode assembly 20 is accommodated in the shell 10, the electrode assembly 20 is of a jelly-roll structure, the electrode assembly 20 includes a negative electrode plate 21, along a winding direction X of the electrode assembly, an elongation at break of the negative electrode plate 21 is X₀, along an extension direction Y of a winding axis of the electrode assembly, an elongation of the negative electrode plate 21 is X₁, and along a thickness direction K of the electrode assembly, an expansion rate of the electrode assembly 20 is X₂, satisfying: 0≤X₀−(X₁+X₂)≤2%. When the battery cell 100 is in the fully charged state, the length of the negative electrode plate 21 along the extension direction Y of the winding axis of the electrode assembly is X₁₁, and a dimension of the electrode assembly 20 along the thickness direction thereof is X₂₁. When the battery cell 100 is in the fully discharged state, the length of the negative electrode plate 21 along the extension direction Y of the winding axis of the electrode assembly is X₁₂, the dimension of the electrode assembly 20 along the thickness direction thereof is X₂₂, the dimension of the electrode assembly 20 along the width direction thereof is b, X₁=(X₁₁−X₁₂)/X₁₂, X₂=(X₂₁−X₂₂)/b, and the extension direction Y of the winding axis of the electrode assembly, the thickness direction K of the electrode assembly, and the width direction Z of the electrode assembly are perpendicular to each other.

If X₀−(X₁+X₂)<0, when the battery cell 100 is in the fully charged state, the negative electrode plate 21 is prone to expansion and breakage, resulting in capacity loss and burrs generated after the negative electrode plate 21 breaks to easily cause safety problems. If X₀−(X₁+X₂)>2%, when the battery cell 100 is in the fully charged state, the risk of breakage of the negative electrode plate 21 is low, but the production cost increases. Therefore, 0≤X₀−(X₁+X₂)≤2% can not only reduce the risk of expansion and breakage of the negative electrode plate when the battery cell 100 is fully charged and improve the safety performance of the battery cell 100, but also reduce the capacity loss of the battery cell 100 and control the production cost of the battery cell 100.

The shell 10 forms an accommodating space Q. The accommodating space Q may be configured to accommodate the electrode assembly 20, an electrolyte solution, etc. The shell 10 may be a rigid housing, for example, the shell 10 may be a steel shell or an aluminum shell, forming a steel shell battery cell 100 or an aluminum shell battery cell 100. The shell 10 may also be made of a relatively soft material, such as an aluminum laminated film or a steel laminated film, forming a pouch battery cell 100.

The electrode assembly 20 further includes a positive electrode plate 22 and a separator 23, and the negative electrode plate 21, the separator 23, and the positive electrode plate 22 are stacked and wound to form a jelly-roll electrode assembly 20.

The positive electrode plate 22 includes a positive current collector and a positive active material layer, and the positive active material layer is disposed on at least one side of the positive current collector. For a lithium-ion battery cell 100, the positive current collector may be made of aluminum. The positive active material layer may be lithium cobalt oxide, lithium iron phosphate, ternary lithium, lithium manganate, etc. The positive current collector may be a composite current collector or a non-composite current collector.

The negative electrode plate 21 includes a negative current collector and a negative active material layer, and the negative active material layer is disposed on at least one side of the negative current collector. For the lithium-ion battery cell 100, the negative current collector may be made of copper, and the negative active material may be carbon, silicon, etc. The negative current collector may be a composite current collector or a non-composite current collector.

In some embodiments, the negative electrode plate 21 includes a negative active material, and the negative active material includes silicon. The negative active material includes silicon, which is conducive to making the battery cell 100 have the advantages such as high energy density, low cost, and environmental friendliness.

In some embodiments, a weight percentage content of the silicon in the negative active material is C, where 0<C<100%.

The weight percentage content of the silicon in the negative active material is less than 100%, that is, the negative active material further includes other materials, such as a binder, graphite, etc. Exemplarily, the weight percentage content C of the silicon in the negative active material is 10%, 20%, 30%, 40%, 50%, 60%, 70%, 80%, 90%, etc.

The weight percentage content of the silicon in the negative active material is greater than 0 and less than 100%, which not only is conducive to making the battery cell 100 have the advantages such as high energy density and environmental friendliness, but also further controls the cost of the battery cell 100.

In some embodiments, 15%≤C≤80%.

Exemplarily, C may be 15%, 25%, 35%, 45%, 55%, 65%, 75%, 80%, etc.

The weight percentage content of the silicon in the negative active material is greater than or equal to 15%, enabling the battery cell 100 to achieve relatively high energy density, and the weight percentage content of the silicon in the negative active material is less than or equal to 80%, which is conducive to further controlling the cost of the battery cell 100.

The content of the silicon in the negative electrode plate 21 can be tested by ICP-AES. The specific testing method is: taking an electrode material, i.e., a negative active material, on the negative current collector side of the negative electrode plate 21, weighing the mass of the electrode material as M_{negative}, digesting M_{negative} in a hydrofluoric acid solution with a volume of V_{negative}, using inductively coupled atomic emission spectroscopy (ICP-AES) to test the silicon concentration in the solution as n_{negative}, using the concentration and solution volume to calculate the total mass of silicon as m_{negative}=n_{negative}*V_{negative}, and then the average silicon content of the electrode material on this side being m_{negative}/M_{negative}.

In some embodiments, the negative active material further includes graphite. The negative active material further includes the graphite, which is conducive to improving the stability of the battery cell 100.

The separator 23 insulatively separates the positive electrode plate 22 and the negative electrode plate 21, thereby reducing the risk of short circuits in the battery cell 100. The separator 23 may be made of a material such as polypropylene (PP) or polyethylene (PE).

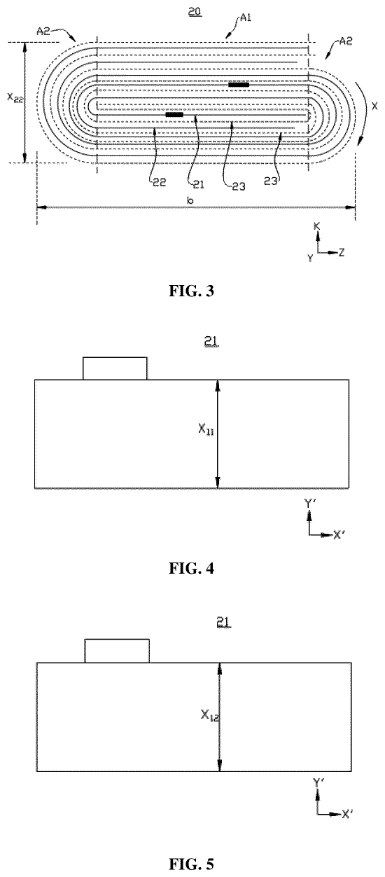

As shown in FIG. 2 and FIG. 3, the electrode assembly 20 includes a straight region A1 and two bent regions A2. Along a first direction, the two bent regions A2 are respectively connected to both ends of the straight region A1. The straight region A1 is the main body position of the electrode assembly 20, and the bent regions A2 are the corners of the electrode assembly 20. The first direction is the width direction Z of the electrode assembly.

The expansion of the negative electrode plate 21 pulls the negative electrode plate 21, causing deformation of the negative electrode plate 21 in both the winding direction X of the electrode assembly and the width direction of the negative electrode plate 21. During expansion, the elongation rate of the negative electrode plate 21 in the width direction thereof is close to that in the winding direction X of the electrode assembly. One reason for breakage of the negative electrode plate 21 is the expansion of the negative electrode plate 21 in the winding direction X of the electrode assembly. Since the elongation rate of the negative electrode plate 21 in the width direction thereof is easier to measure than that in the winding direction X of the electrode assembly when the negative electrode plate 21 is in a wound state, the elongation rate of the negative electrode plate 21 in the width direction thereof can be used as a substitute for the elongation rate of the negative electrode plate 21 in the winding direction X of the electrode assembly.

The winding axis direction of the electrode assembly 20 corresponds to the width direction of the unfolded negative electrode plate 21. The winding direction X of the electrode assembly corresponds to the length direction of the unfolded negative electrode plate 21.

The elongation at break refers to the ratio of the elongation length before and after stretching to the length before stretching when a material is stretched to break, usually expressed as a percentage. The elongation at break of the negative electrode is a common indicator characterizing the ability of the negative electrode plate 21 to resist deformation without breakage. The elongation at break of the negative electrode plate 21 is the ratio of the elongation length before and after stretching to the length before stretching when the negative electrode plate 21 is stretched to break. The testing method for the elongation at break of the negative electrode plate 21 can be as follows:

Testing method: cutting the negative electrode plate 21 into strips with a width of a and a length greater than 10 mm (the length is recorded as L), fixing one end to a lower end of a tensile machine, fixing the other end to an upper end of the tensile machine, keeping the two ends on the same vertical plane, setting the speed of the tensile machine to 50 mm/min, the length of the negative electrode plate 21 when it is broken being L′, recording the stretching amount as ΔL=L′−L when the negative electrode breaks, and then the copper foil strength being X₀=ΔL/L.

The elongation at break of the negative electrode plate 21 is mainly related to the material of the negative current collector. Commonly used negative current collectors include copper foil, polymer-copper layer composite current collectors, etc. Generally, the elongation at break of the polymer-copper layer composite current collectors is greater than the elongation at break of the copper foil.

The fully charged state of the battery cell 100 refers to charging the battery cell 100 to the upper limit voltage. The full charge test procedure for the battery cell 100 in this application may be: charging the battery cell at a constant current at a specified current (e.g., 0.2 C) to 4.25 V, and then charging the same at a constant voltage to 0.02 C. The upper limit voltage varies for battery cells 100 of different systems, and the upper limit voltage of the battery cell 100 may refer to the rated upper limit voltage of the battery cell 100.

The fully discharged state of the battery cell 100 refers to discharging the battery cell 100 to the lower limit voltage. The full discharge test procedure for the battery cell 100 may be: charging the battery cell at a constant current at a specified current, e.g., 0.2 C, to 2.5 V. The lower limit voltage varies for battery cells 100 of different systems, and the lower limit voltage of the battery cell 100 may refer to the rated lower limit voltage of the battery cell 100.

X₀−(X₁+X₂) may be 0.01%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, etc.

In some embodiments, 0.4%≤X₀−(X₁+X₂)≤1.5%.

Exemplarily, X₀−(X₁+X₂) may be 0.4%, 0.45%, 0.55%, 0.65%, 0.75%, 0.85%, 0.95%, 1.05%, 1.15%, 1.25%, 1.35%, 1.45%, 1.5%, etc.

0.4%≤X₀−(X₁+X₂), such that the risk of expansion and breakage of the negative electrode plate 21 after the number of cycles of the battery cell 100 increases can be reduced, thereby further improving the safety performance of the battery cell 100 and prolonging the service life of the battery cell 100; and X₀−(X₁+X₂)≤1.5%, which is conducive to controlling the production cost of the battery cell 100 within a reasonable range. Therefore, 0.4%≤X₀−(X₁+X₂)≤1.5% can not only further reduce the risk of expansion and breakage of the negative electrode plate 21 after the number of cycles of the battery cell 100 increases, thereby further improving the safety performance of the battery cell 100 and prolonging the service life of the battery cell 100, but also control the production cost of the battery cell 100.

In some embodiments, the battery cell 100 includes a plurality of electrode assemblies 20, and the plurality of electrode assemblies 20 are stacked along the thickness direction K of the electrode assemblies.

The term ‘plurality of’ refers to two or more. For example, the battery cell 100 include three electrode assemblies 20, four electrode assemblies 20, five electrode assemblies 20, six electrode assemblies 20, etc.

The battery cell 100 includes a plurality of electrode assemblies 20. When the capacity of the battery cell 100 remains constant, compared with the case that the battery cell 100 includes a single electrode assembly 20, the battery cell 100 in this solution includes the plurality of electrode assemblies 20, each electrode assembly 20 may have a small thickness, and the smaller the thickness of the electrode assemblies 20, the lower the risk of breakage of negative electrode plates of the electrode assemblies 20, such that the safety performance of the battery cell 100 is better.

In some embodiments, the number of electrode assemblies 20 does not exceed four. For example, the number of electrode assemblies 20 may be two, three, or four. The number of electrode assemblies 20 does not exceed four, which can reduce the process complexity, improve the production efficiency and reduce the production cost.

In some embodiments, an accommodating space A is formed inside the shell 10, and a dimension of the accommodating space Q along the thickness direction K of the electrode assembly is H, where 5 mm≤H≤20 mm.

Along the thickness direction K of the electrode assembly, the shell 10 includes a first wall 11 and a second wall 12 opposite to each other. The dimension H of the accommodating space Q along the thickness direction K of the electrode assembly is a distance between an inner surface of the first wall 11 and an inner surface of the second wall 12 along the thickness direction K.

Exemplarily, H may be 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, etc.

When 5 mm≤H, the internal space of the shell 10 of the battery cell 100 is relatively large, which is conducive to making the battery cell 100 and the like have relatively high energy density, and also making the processing of the shell 10 easy; and when H≤20 mm, the processing difficulty and production cost of the battery cell 100 are reduced.

In some embodiments, 6 mm≤H≤15 mm.

Exemplarily, H may be 6 mm, 6.5 mm, 7.5 mm, 8.5 mm, 9.5 mm, 10.5 mm, 11.5 mm, 12.5 mm, 13.5 mm, 14.5 mm, 15 mm, etc.

When 6 mm≤H, the internal space of the shell 10 of the battery cell 100 is relatively large, which is conducive to making the battery cell 100 and the like have high energy density, and also making the processing of the shell 10 easy; and when H≤15 mm, the processing difficulty and production cost of the battery cell 100 are further reduced.

In some embodiments, a number of electrode assemblies 20 is N, the accommodating space Q is formed inside the shell 10, and the dimension of the accommodating space Q in the thickness direction K of the electrode assembly is H, where N≥2, and 0.5H/N≤X₂₂≤1.5H/N.

When 0.5H/N≤X₂₂, the battery cell 100 has a large capacity, and when X₂₂≤1.5H/N, it is avoided that the risk of expansion and breakage of the negative electrode plate 21 is increased due to the excessive thickness of the electrode assembly 20, and the safety performance of the battery cell 100 is improved.

As shown in FIG. 3, in some embodiments, 2.5 mm≤X₂₂≤10 mm.

Exemplarily, X₂₂ may be 2.5 mm, 3 mm, 4 mm, 5 mm, 6 mm, 7 mm, 8 mm, 9 mm, 10 mm, etc.

The thickness of the electrode assembly 20 is greater than or equal to 2.5 mm, which is conducive to making the electrode assembly 20 have a relatively high capacity and facilitates the production and processing of the electrode assembly 20; and the thickness of the electrode assembly 20 is less than or equal to 10 mm, thereby reducing the risk of expansion and breakage of the negative electrode plate 21 of the battery cell 100 in the fully charged state, and improving the safety of the battery cell 100.

In some embodiments, 3 mm≤X₂₂≤7.5 mm.

Exemplarily, X₂₂ may be 3 mm, 3.5 mm, 4.5 mm, 5.5 mm, 6.5 mm, 7.5 mm, etc.

The thickness of the electrode assembly 20 is greater than or equal to 3 mm, which is conducive to making the electrode assembly 20 have a relatively high capacity and facilitates the production and processing of the electrode assembly 20; and the thickness of the electrode assembly 20 is less than or equal to 7.5 mm, thereby further reducing the risk of expansion and breakage of the negative electrode plate 21 of the battery cell 100 in the fully charged state, and further improving the safety of the battery cell 100.

An embodiment of this application further provides an electrical device, and the electrical device includes the battery cell 100 according to any one of the above embodiments. The battery cell 100 is configured to provide electrical energy to the electrical device.

The battery cell 100 provided according to any one of the above embodiments has good safety, which is conducive to improving the electrical safety of the electrical device powered by the battery cell 100.

Through comparative testing of the breakage performance of the negative electrode plates 21 of the battery cells 100 provided according to the embodiments of this solution, the data in Table 1 is obtained. The other parameters and structures of the battery cell 100 in the embodiments and the battery cell 100 in the comparative embodiments are the same except for the parameters listed in Table 1.

Measurement of X₁₁ and X₂₁: charging the battery cell 100 prepared in each embodiment and comparative embodiment at a constant current of 0.2 C to 4.25 V, and then charging at a constant voltage of 4.25 V to 0.02 C for cutoff, and then disassembling the battery cell after standing for 15 minutes; and measuring the thickness X₂₁ of each electrode assembly when fully charged and the length X₁₁ of the negative electrode plate in each electrode assembly along the extension direction of the winding axis (i.e., the width direction of the negative electrode plate after unfolded) with a ruler.

Measurement of X₁₂ and X₂₂: charging the battery cell 100 prepared in each embodiment and comparative embodiment at a constant current of 0.2 C to 4.25 V, then charging at a constant voltage of 4.25 V to 0.02 C for cutoff, and then discharging at a constant current of 0.2 C to 2.5 V, and then disassembling the battery cell after standing for 15 minutes; and measuring the thickness X₂₂ of each electrode assembly when fully discharged and the length X₁₂ of the negative electrode plate in each electrode assembly in the extension direction of the winding axis (i.e., the width direction of the negative electrode plate after unfolded) with a ruler.

TABLE 1

| | | Thickness | | | | | | | | | |
|---|---|---|---|---|---|---|---|---|---|---|---|
| | | of copper | | X₂₂/ | N/ | | | | | X₀- | Whether |
| Group | C | foil | X₁ | mm | mm | X₂₁-X₂₂ | b | X₂ | X₀ | (X₁ + X₂) | to break |
| Embodiment 1 | 15% | 4 μm | 0.60% | 4 | 2 | 0.23 | 30 | 0.8% | 2.0% | 0.6% | No |
| Embodiment 2 | 30% | 4 μm | 0.8% | 4 | 2 | 0.38 | 40 | 1.0% | 2.0% | 0.3% | No break when |
| | | | | | | | | | | | fully charged, |
| | | | | | | | | | | | but break after |
| | | | | | | | | | | | 100 cycles |
| Embodiment 3 | 30% | 4 μm | 0.80% | 2.5 | 3 | 0.2375 | 40 | 0.6% | 2.0% | 0.6% | No |
| Embodiment 4 | 30% | 6 μm | 0.5% | 4 | 2 | 0.38 | 40 | 1.0% | 2.0% | 0.6% | No |
| Embodiment 5 | 30% | Copper foil- | 0.8% | 4 | 2 | 0.38 | 40 | 1.0% | 3.0% | 1.3% | No |
| | | polymer | | | | | | | | | |
| | | composite | | | | | | | | | |
| | | current | | | | | | | | | |
| | | collector | | | | | | | | | |
| Embodiment 6 | 30% | 4 μm | 0.8% | 4 | 2 | 0.38 | 60 | 0.6% | 2.0% | 0.6% | No |
| Embodiment 7 | 30% | 4 μm | 0.8% | 4 | 2 | 0.38 | 50 | 0.8% | 2.0% | 0.4% | No |
| Embodiment 8 | 30% | 6 μm | 0.50% | 4.5 | 1 | 0.4275 | 40 | 1.1% | 2.0% | 0.4% | No |
| | 30% | 4 μm | 0.80% | 3.5 | 1 | 0.3325 | 40 | 0.8% | 2.0% | 0.4% | No |
| Embodiment 9 | 30% | Copper foil- | 0.8% | 2.5 | 3 | 0.2375 | 40 | 1.0% | 3.0% | 1.6% | No |
| | | polymer | | | | | | | | | |
| | | composite | | | | | | | | | |
| | | current | | | | | | | | | |
| | | collector | | | | | | | | | |
| Comparative | 15% | 4 μm | 0.6% | 8 | 1 | 0.46 | 30 | 1.5% | 2.0% | −0.1% | Yes |
| Embodiment 1 | | | | | | | | | | | |
| Comparative | 30% | 4 μm | 0.8% | 8 | 1 | 0.76 | 40 | 1.9% | 2.0% | −0.7% | Yes |
| Embodiment 2 | | | | | | | | | | | |

As can be seen from Table 1:
(1) Comparing Embodiment 1 and Comparative Embodiment 1, it can be seen that when the dimension of the accommodating space Q of the shell 10 of the battery cell 100 along the thickness direction K of the electrode assembly remains unchanged and the capacity of the battery cell 100 is constant, the battery cell 100 in Embodiment 1 includes two electrode assemblies 20, compared to that the battery cell 100 in Comparative Embodiment 1 includes one electrode assembly 20, the thickness of a single electrode assembly 20 in Embodiment 1 is smaller, and the negative electrode plate 21 does not break in the fully charged state. Comparing Embodiment 3 and Comparative Embodiment 2, it can be seen that when the dimension of the accommodating space Q of the shell 10 of the battery cell 100 along the thickness direction K of the electrode assembly remains unchanged and the capacity of the battery cell 100 is constant, the battery cell 100 in Embodiment 3 includes three electrode assemblies 20, compared to that the battery cell 100 in Comparative Embodiment 2 includes one electrode assembly 20, the thickness of a single electrode assembly 20 in Embodiment 3 is smaller, and the negative electrode plate 21 does not break in the fully charged state. In summary, by reducing the thickness of a single electrode assembly 20, it is conducive to reducing the risk of expansion and breakage of the negative electrode plate 21 and improving the safety performance of the battery cell 100.
(2) Comparing Embodiment 2 and Comparative Embodiment 2, it can be seen that when the dimension of the accommodating space Q of the shell 10 of the battery cell 100 along the thickness direction K of the electrode assembly remains unchanged and the capacity of the battery cell 100 is constant, the battery cell 100 in Embodiment 2 includes two electrode assemblies 20, compared to that the battery cell 100 in Comparative Embodiment 2 includes one electrode assembly 20, the thickness of a single electrode assembly 20 in Embodiment 2 is smaller and the width is larger, and the negative electrode plate 21 does not break in the fully charged state.

Comparing Embodiment 6 and Comparative Embodiment 2, it can be seen that when the dimension of the accommodating space Q of the shell 10 of the battery cell 100 along the thickness direction K of the electrode assembly remains unchanged and the capacity of the battery cell 100 is constant, the battery cell 100 in Embodiment 6 includes three electrode assemblies 20, compared to that the battery cell 100 in Comparative Embodiment 2 includes one electrode assembly 20, the thickness of a single electrode assembly 20 in Embodiment 6 is smaller, and the negative electrode plate 21 does not break in the fully charged state.

Comparing Embodiment 8 and Comparative Embodiment 2, it can be seen that when the dimension of the accommodating space Q of the shell 10 of the battery cell 100 along the thickness direction K of the electrode assembly remains unchanged and the capacity of the battery cell 100 is constant, the battery cell 100 in Embodiment 8 includes two electrode assemblies 20 of different thicknesses, compared to that the battery cell 100 in Comparative Embodiment 2 includes one electrode assembly 20, the thickness of a single electrode assembly 20 in Embodiment 8 is smaller, and the negative electrode plate 21 does not break in the fully charged state.

In summary, by reducing the thickness of each electrode assembly 20 and increasing the width of the electrode assembly 20, it is conducive to reducing the risk of expansion and breakage of the negative electrode plate 21 and improving the safety performance of the battery cell 100.
(3) Comparing Embodiment 4 and Embodiment 2, the thickness of the current collector of the negative electrode plate 21 in Embodiment 4 is increased relative to Embodiment 2, such that the elongation rate of the negative electrode plate 21 in Embodiment 4 in the winding direction X of the electrode assembly and the extension direction Y of the winding axis of the electrode assembly is lower relative to Embodiment 2. Therefore, increasing the thickness of the negative current collector is conducive to reducing the elongation rate of the negative electrode plate 21 in the winding direction X of the electrode assembly and the extension direction Y of the winding axis of the electrode assembly during expansion, thereby reducing the risk of breakage of the negative electrode plate 21.
(4) Comparing Embodiment 4 and Embodiment 5, the current collector of the negative electrode plate 21 in Embodiment 5 adopts a copper foil-polymer composite current collector, while the current collector of the negative electrode plate 21 in Embodiment 4 adopts a copper foil current collector, such that the elongation at break of the negative electrode plate 21 in Embodiment 5 is larger relative to Embodiment 4. Therefore, the negative electrode plate 21 adopts the composite current collector, which is conducive to increasing the elongation at break of the negative electrode plate 21, thereby reducing the risk of breakage of the negative electrode plate 21
(5) Comparing Embodiment 2, Embodiment 6, and Embodiment 7, it can be seen that when the number of electrode assemblies 20 in the battery cell 100 remains unchanged and the thickness of the electrode assemblies 20y remains unchanged, the greater the width of the electrode assemblies 20, the greater X₀−(X₁+X₂), the lower the risk of breakage of the negative electrode plate 21.
(6) Comparing Embodiment 9 and Embodiment 5, it can be seen that when the dimension of the accommodating space Q of the shell 10 of the battery cell 100 along the thickness direction K of the electrode assembly remains unchanged and the capacity of the battery cell 100 is constant, the number of electrode assemblies 20 is further increased in Embodiment 9 relative to Embodiment 5, the thickness of a single electrode assembly 20 is reduced, and the negative electrode plate 21 does not break. However, since Embodiment 5 already meets the requirements, there is no need to further split into three electrode assemblies 20 on the basis of Embodiment 5 to further reduce the thickness of the single electrode assembly 20.

TABLE 2

| | | Whether the negative | |
|---|---|---|---|
| | | electrode plate 21 | Energy density |
| Group | X₀ − (X₁ + X₂) | breaks | (Wh/L) |
| Comparative | −0.1% | Yes | 700 |
| Embodiment 3 | | | |
| Embodiment 10 | 0 | No break when fully | 699 |
| | | charged, but break | |
| | | after 10 cycles | |
| Embodiment 11 | 0.1% | No break when fully | 698 |
| | | charged, but break | |
| | | after 50 cycles | |
| Embodiment 12 | 0.3% | No break when fully | 697.5 |
| | | charged, but break | |
| | | after 100 cycles | |
| Embodiment 13 | 0.4% | No | 697 |
| Embodiment 14 | 0.6% | No | 696 |
| Embodiment 15 | 0.8% | No | 693 |
| Embodiment 16 | 1% | No | 688 |
| Embodiment 17 | 1.2% | No | 683 |
| Embodiment 18 | 1.5% | No | 680 |
| Embodiment 19 | 1.8% | No | 675 |
| Embodiment 20 | 2% | No | 670 |
| Embodiment 21 | 2.5% | No | 660 |

It can be seen from Table 2 that, in combination with Comparative Embodiment 3 and Embodiments 10 to 21, when X₀−(X₁+X₂) is −0.1% or 0, the negative electrode plates 21 all break after the battery cells 100 are fully charged. When X₀−(X₁+X₂) is 0.1%, 0.3%, 0.4%, 0.8%, 1%, 1.2%, 1.5%, 1.8%, 2%, or 2.5%, the negative electrode plates 21 do not break when the battery cells 100 are fully charged. Therefore, when X₀−(X₁+X₂)≥0, the negative electrode plate 21 does not break when the battery cell 100 is in the fully charged state. As X₀−(X₁+X₂) increases, the energy density of the battery cell 100 gradually decreases. The energy density of the battery cell 100 when X0−(X1+X2) is 2.5% is lower than the energy density of the battery cell 100 when X₀−(X₁+X₂) is 0.1%, 0.3%, 0.4%, 0.8%, 1%, 1.2%, 1.5%, 1.8%, or 2%. Therefore, 0≤X₀−(X₁+X₂)≤2% can not only reduce the risk of expansion and breakage of the negative electrode plate when the battery cell 100 is fully charged and improve the safety performance of the battery cell 100, but also reduce the capacity loss of the battery cell 100 and make the battery cell 100 have good energy density.

Please continue to refer to Table 2. When X₀−(X₁+X₂) is 0.1% or 0.3%, the negative electrode plate 21 does not break when the battery cell 100 is fully charged. However, after the battery cell 100 is cycled a certain number of times, the negative electrode plate 21 will break, resulting in a reduction in the service life of the battery cell 100. When X₀−(X₁+X₂) is 0.4%, 0.8%, 1%, 1.2%, 1.5%, 1.8%, 2%, or 2.5%, the negative electrode plate 21 does not break when the battery cell 100 is fully charged and as the number of cycles of the battery cell 100 increases. Therefore, 0.4%≤X₀−(X₁+X₂), such that the risk of expansion and breakage of the negative electrode plate 21 after the number of cycles of the battery cell 100 increases can be reduced, thereby further improving the safety performance of the battery cell 100 and prolonging the service life of the battery cell 100. The battery cell 100 when X₀−(X₁+X₂) is 0.8%, 1%, 1.2%, or 1.5% has better energy density than the battery cell 100 when X₀−(X₁+X₂) is 1.8% or 2%. Therefore, 0.4%≤X₀−(X₁+X₂)≤1.5% can not only further reduce the risk of expansion and breakage of the negative electrode plate 21 after the number of cycles of the battery cell 100 increases, thereby further improving the safety performance of the battery cell 100 and prolonging the service life of the battery cell 100, but also achieve the better energy density.

Cycle tests are conducted on Embodiments 22 to 26 to obtain the data in Table 3. In the embodiments of Table 3, the dimensions of the accommodating space Q of the shell 10 of the battery cell 100 along the thickness direction K of the electrode assembly are the same, and the capacities of the battery cells 100 are the same.

TABLE 3

| | | Thickness | | | | | | | | | | Energy |
|---|---|---|---|---|---|---|---|---|---|---|---|---|
| | | of copper | | X₂₂/ | N/ | | | | | X₀- | Whether | density |
| Group | C | foil | X₁ | mm | mm | X₂₁-X₂₂ | b | X₂ | X₀ | (X₁ + X₂) | to break | (Wh/L) |
| Embodiment 22 | 15% | 4 μm | 0.6% | 8 | 1 | 0.48 | 30 | 1.6% | 2% | −0.20% | Yes | 700 |
| Embodiment 23 | 15% | 4 μm | 0.60% | 4 | 2 | 0.24 | 30 | 0.8% | 2% | 0.60% | No | 696 |
| Embodiment 24 | 15% | 4 μm | 0.60% | 2.67 | 3 | 0.1602 | 30 | 0.5% | 2% | 0.9% | No | 692 |
| Embodiment 25 | 15% | 4 μm | 0.60% | 2 | 4 | 0.12 | 30 | 0.4% | 2% | 1.0% | No | 688 |
| Embodiment 26 | 15% | 4 μm | 0.60% | 1.6 | 5 | 0.096 | 30 | 0.3% | 2% | 1.1% | No | 650 |

It can be seen from Table 3 that by comparing Embodiment 22 and Embodiment 23 to Embodiment 26, when the dimension of the accommodating space Q of the shell 10 of the battery cell 100 along the thickness direction K of the electrode assembly remains unchanged and the capacity of the battery cell 100 is constant, the battery cells 100 in Embodiment 23, Embodiment 24, Embodiment 25, and Embodiment 26 include two electrode assemblies 20, three electrode assemblies 20, four electrode assemblies 20, and five electrode assemblies 20, respectively. Compared to that the battery cell 100 in Embodiment 22 includes one electrode assembly 20, the thickness of each electrode assembly 20 in Embodiment 23 to Embodiment 26 is smaller, the larger X₀−(X₁+X₂), the lower the risk of expansion and breakage of the negative electrode plate 21 when the battery cell 100 is fully charged, and Embodiment 23 to Embodiment 25 have a higher energy density than Embodiment 26. Therefore, under the condition that the accommodating space Q is certain, by increasing the number of electrode assemblies 20 and reducing the thickness of the electrode assemblies 20, it is conducive to reducing the risk of expansion and breakage of the negative electrode plate 21, improving the safety performance of the battery cell 100, and ensuring the energy density of the battery cell 100.

The above is only a preferred embodiment of this application, and is not intended to limit this application, and this application is subject to various changes and variations for a person skilled in the art. Any and all modifications, equivalent replacements, improvements, and the like made without departing from the spirit and principles of this application still fall within the protection scope of this application.

What is claimed is:

1. A battery cell, comprising:
a shell; and
an electrode assembly, accommodated in the shell;
wherein the electrode assembly is of a jelly-roll structure, the electrode assembly comprises a negative electrode plate;
along a winding direction of the electrode assembly, an elongation at break of the negative electrode plate is X₀; along an extension direction of a winding axis of the electrode assembly, an elongation of the negative electrode plate is X₁; and along a thickness direction of the electrode assembly, an expansion rate of the electrode assembly is X₂; 0≤X₀−(X₁+X₂)≤2%;
wherein when the battery cell is in a fully charged state, a length of the negative electrode plate along the extension direction of the winding axis of the electrode assembly is X₁₁, and a dimension of the electrode assembly along the thickness direction of the electrode assembly is X₂₁; and. when the battery cell is in a fully discharged state, a length of the negative electrode plate along the extension direction of the winding axis of the electrode assembly is X₁₂, a dimension of the electrode assembly along the thickness direction of the electrode assembly is X₂₂, a dimension of the electrode assembly along a width direction of the electrode assembly is b, X₁=(X₁₁−X₁₂)/X₁₂, X₂=(X₂₁−X₂₂)/b; and the extension direction of the winding axis of the electrode assembly, the thickness direction of the electrode assembly, and the width direction of the electrode assembly are perpendicular to each other.

2. The battery cell according to claim 1, wherein 0.4%≤X₀−(X₁+X₂)≤1.5%.

3. The battery cell according to claim 1, wherein the negative electrode plate comprises a negative active material, and the negative active material comprises silicon.

4. The battery cell according to claim 3, wherein a weight percentage content of silicon in the negative active material is C, 0<C<100%.

5. The battery cell according to claim 4, wherein 15%≤C≤80%.

6. The battery cell according to claim 3, wherein the negative active material further comprises graphite.

7. The battery cell according to claim 1, wherein the battery cell comprises a plurality of electrode assemblies; wherein a number of electrode assemblies in the plurality of electrode assemblies is N, an accommodating space is formed inside the shell, and a dimension of the accommodating space along the thickness direction of the electrode assembly is H, wherein N≥2, and 0.5H/N≤X₂₂≤1.5H/N.

8. The battery cell according to claim 7, wherein the plurality of electrode assemblies are stacked along the thickness direction of the electrode assemblies; and the number of the electrode assemblies does not exceed four.

9. The battery cell according to claim 1, wherein an accommodating space is formed inside the shell, and a dimension of the accommodating space along the thickness direction of the electrode assembly is H, wherein 5 mm≤H≤20 mm.

10. The battery cell according to claim 9, wherein 6 mm≤H≤15 mm.

11. The battery cell according to claim 1, wherein 2.5 mm≤X₂₂≤10 mm.

12. The battery cell according to claim 11, wherein 3 mm≤X₂₂≤7.5 mm.

13. An electrical device, comprising a battery cell, the battery cell comprising:
a shell; and
an electrode assembly, accommodated in the shell, wherein the electrode assembly is of a jelly-roll structure, the electrode assembly comprises a negative electrode plate; along a winding direction of the electrode assembly, an elongation at break of the negative electrode plate is X₀; along an extension direction of a winding axis of the electrode assembly, an elongation of the negative electrode plate is X₁; and along a thickness direction of the electrode assembly, an expansion rate of the electrode assembly is X₂; 0≤X₀−(X₁+X₂)≤2%;
wherein when the battery cell is in a fully charged state, a length of the negative electrode plate along the extension direction of the winding axis of the electrode assembly is X₁₁, and a dimension of the electrode assembly along the thickness direction of the electrode assembly is X₂₁; and. when the battery cell is in a fully discharged state, a length of the negative electrode plate along the extension direction of the winding axis of the electrode assembly is X₁₂, a dimension of the electrode assembly along the thickness direction of the electrode assembly is X₂₂, a dimension of the electrode assembly along a width direction of the electrode assembly is b, X₁=(X₁₁−X₁₂)/X₁₂, X₂=(X₂₁−X₂₂)/b; and the extension direction of the winding axis of the electrode assembly, the thickness direction of the electrode assembly, and the width direction of the electrode assembly are perpendicular to each other.

14. The electrical device according to claim 13, wherein 0.4%≤X₀−(X₁+X₂)≤1.5%.

15. The electrical device according to claim 13, wherein the negative electrode plate comprises a negative active material, and the negative active material comprises silicon.

16. The electrical device according to claim 15, wherein a weight percentage content of silicon in the negative active material is C, 0<C<100%.

17. The electrical device according to claim 16, wherein 15%≤C≤80%.

18. The electrical device according to claim 15, wherein the negative active material further comprises graphite.

19. The electrical device according to claim 13, wherein the battery cell comprises a plurality of electrode assemblies; wherein a number of electrode assemblies in the plurality of electrode assemblies is N, an accommodating space is formed inside the shell, and a dimension of the accommodating space along the thickness direction of the electrode assembly is H, wherein N≥2, and 0.5H/N≤X₂₂≤1.5H/N.

20. The electrical device according to claim 19, wherein 6 mm≤H≤15 mm.
